(19) United States
(12) Patent Application Publication
(10) Pub. No.: US 2006/0163088 A1
(43) Pub. Date: Jul. 27, 2006

(54) Amperometric sensor with counter electrode isolated from fill solution

(76) Inventors: Joshua Xu, Irvine, CA (US); Chang-Dong Feng, Long Beach, CA (US)

Correspondence Address: WESTMAN, CHAMPLIN & KELLY, P.A.;Suite 1400, International Centre, 900 Second Avenue South, Minneapolis, MN, 55402-3319, US

(21) Appl. No.: 11/340,834

(22) Filed: Jan. 26, 2006

Related U.S. Application Data
(60) Provisional application No. 60/647,121, filed on Jan. 26, 2005.

(51) Int. Cl. G01F 1/64; G01N 27/26

(52) U.S. Cl. 205/793; 204/415

(57) ABSTRACT

An amperometric sensor includes a sensor body having a distal end and an interior containing an electrolytic fill solution. A porous membrane is disposed proximate the distal end to allow diffusion of molecules or ions of interest. A working electrode is disposed within the sensor body proximate the membrane. A counter electrode is disposed to conduct current between the counter electrode and the working electrode. The counter electrode is physically isolated from the electrolytic fill solution. A method of measuring a concentration of the molecules or ions of interest is also provided.

### CROSS-REFERENCE TO RELATED APPLICATION

The present application is based on and claims the benefit of U.S. provisional patent application Ser. No. 60/647,121, filed Jan. 26, 2005, the content of which is hereby incorporated by reference in its entirety.

### BACKGROUND OF THE INVENTION

Amperometric sensors are generally known. In such sensors, molecules or ions of interests react electrically to generate an electrical response that is measured in the form of current flow. One example of a commercially available amperometric sensor is sold under the trade designation 499ACL-03-54-VP by Rosemount Analytical Incorporated of Irvine, Calif.

Amperometric sensors generally include a membrane that is permeable to small ions or molecules of interest. The membrane is generally stretched or otherwise disposed proximate a working electrode, either a cathode or an anode (taking cathode as example) within the sensor. The cathode, in general, is formed of a noble metal such as gold or platinum. A counter electrode, an anode when the working electrode is a cathode, is disposed within the sensor and is electrically coupled to the cathode via an electrolytic fill solution. During operation, the molecules or ions of interest diffuse from the sample through the membrane. Once inside the sensor, the molecules or ions are reduced at the working electrode and undergo an electrochemical change. The reduction produces a current, which flows between the working electrode (cathode) and the counter electrode (anode). The current causes other molecules or ions proximate the counter electrode to also undergo an electrochemical change via oxidation. Measuring the current flowing between the working electrode and the counter electrode provides an indication of the rate at which the molecules or ions of interest diffuse through the membrane into the sensor, which rate is ultimately indicative of the concentration of the molecules or ions in the sample.

There are generally two types of amperometric sensors, those that employ two electrodes, and those that employ three. Three-electrode sensors employ a working electrode, a counter electrode, and a reference electrode. The reduction/oxidation current flows between the working electrode and the counter electrode. In such sensors, the reference electrode is used to measure the potential within the electrolytic fill solution in order to control the current driven through the counter electrode. Three-electrode amperometric sensors may provide added accuracy at extremities of the measurement range and/or provide better linearity in comparison to two electrode amperometric sensors.

Prior art amperometric sensors have both working electrode and the counter electrode in the fill solution chamber. One limitation with prior art amperometric sensors is that, over time, the electrolyte itself can become contaminated by the molecules or ions electrochemically produced at the counter electrode, which may hinder the proper functions of the sensor. Providing an amperometric sensor where the electrolytic fill solution did not become contaminated would represent a significant advance in the art of amperometric sensors.

### SUMMARY

An amperometric sensor includes a sensor body having a distal end and an interior containing an electrolytic fill solution. A porous membrane is disposed proximate the distal end to allow diffusion of molecules or ions of interest. A working electrode is disposed within the sensor body proximate the membrane. A counter electrode is disposed to conduct current between the counter electrode and the working electrode. The counter electrode is physically isolated from the electrolytic fill solution.

A method of measuring a concentration of molecules or ions of interest is also provided. The method includes diffusing molecules or ions of interest across a membrane into the sensor. The diffused molecules or ions of interest are then reduced or oxidized at a working electrode. A current flows between the counter electrode and the working electrode. The counter electrode is separated from any electrolytic fill solution, such that electrochemical reactions taking place at the counter electrode do not impact the fill solution.

### BRIEF DESCRIPTION OF THE DRAWINGS

FIG. 1 is diagrammatic view of an amperometric three-electrode sensor in accordance with the prior art.

FIG. 2 is a diagrammatic view of a three-electrode amperometric sensor in accordance with an embodiment of the present invention.

FIG. 3 is a diagrammatic view of a three-electrode amperometric sensor in accordance with another embodiment of the present invention.

FIG. 4 is a flow diagram of a method of sensing using an amperometric sensor in accordance with an embodiment of the present invention.

### DETAILED DESCRIPTION

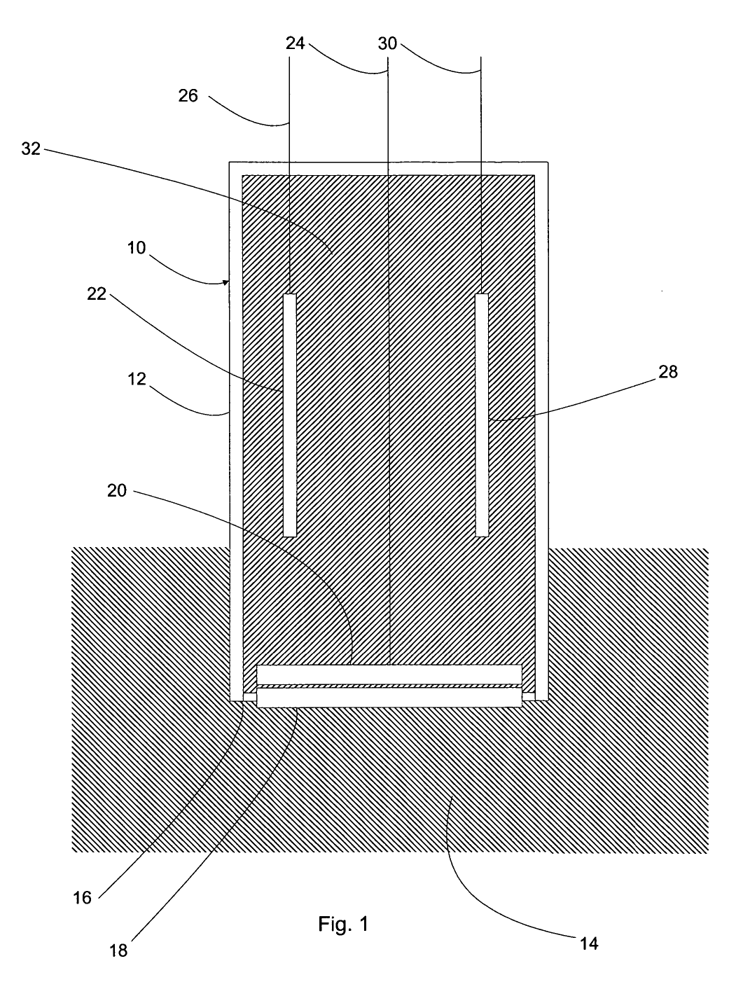

FIG. 1 is diagrammatic view of a three-electrode amperometric sensor in accordance with the prior art. Amperometric sensor 10 includes sensor body 12 that is disposed, or otherwise locatable within sample solution 14. Sensor body 12 includes a distal end 16 with a sensing membrane 18 disposed thereon. Sensing membrane 18 is formed of a relatively porous material that allows molecules of ions of interest in process solution 14 to diffuse across membrane 18 to sensing/working electrode 20. Sensing/working electrode 20 is generally formed of a noble metal, such as platinum or gold. In response to the molecules or ions of interest diffusing across membrane 18, a reduction or oxidation reaction occurs at sensing/working electrode 20 generating a current between the working electrode and counter electrode 22. The ions flow through electrolytic fill solution 32 from sensing/working electrode 20 to counter electrode 22. Accordingly, sensing the current flow across leads 24 and 26 provides an indication of such current flow and thus an indication of the concentration of the molecules or ions in sample 14. Reference electrode 28 is coupled to lead 30 and provides an indication of the potential of electrolytic fill solution 32 within sensor body 12, which potential can be used by an analyzer to adjust, or affect the electrical properties and interactions within sensor 10.

One problem with sensors of the type illustrated in FIG. 1 is that electrolytic fill solution 32 can, over time, become contaminated. This is believed to occur, based at least in part, upon the electrochemical reaction occurring at counter electrode 22, generating undesirable ions or substances. The product(s) of the reaction occurring at counter electrode 22 may contaminate electrolytic fill solution 32 and/or passivate working electrode 20 resulting in degraded sensor performance, or other forms of deterioration.

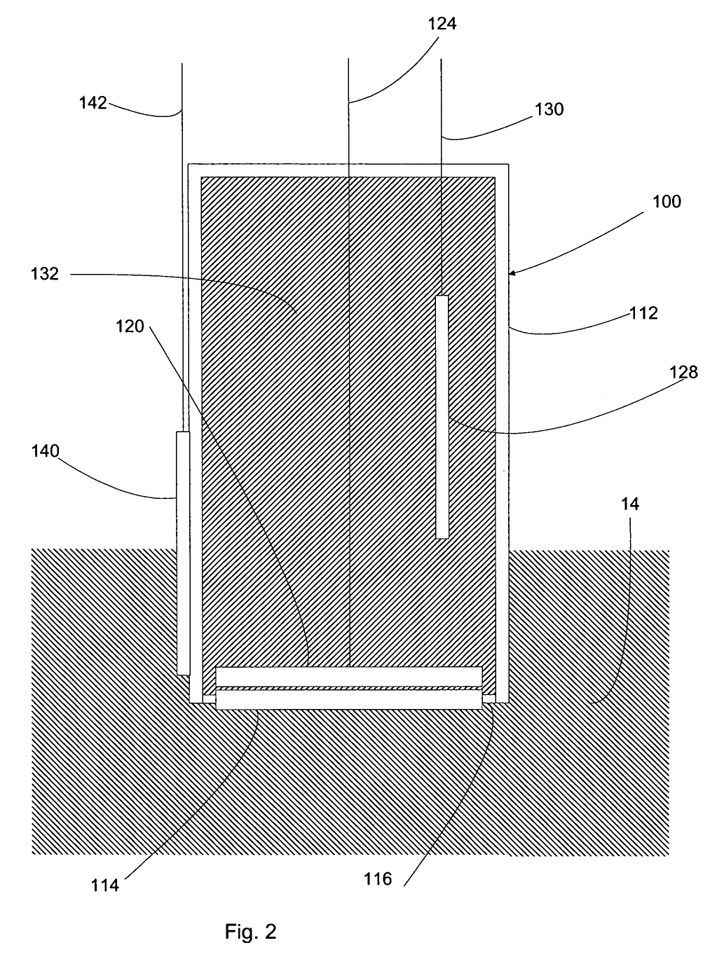

FIG. 2 is a diagrammatic view of a three-electrode amperometric sensor in accordance with an embodiment of the present invention. Sensor 100 includes some components that are similar to sensor 10, and like components are numbered similarly. Sensor 100 includes sensor body 112 having a porous membrane 114 disposed at distal end 116. By “porous” it is meant that the molecules or ions of interest can diffuse across membrane 114. Moreover, membrane 114 is constructed from a material that allows ions to pass therethrough. Examples of suitable materials for membrane 114 include, but are not limited to, hydrophilic polytetrafluoroethylene (PTFE), hydrophilic polyvinylidene fluoride, and hydrophilic polyethersulfone. Sensor 100 includes sensing/working electrode 120 disposed within sensor body 112 proximate membrane 114.

Electrolytic fill solution 132 is also disposed within the chamber within sensor body 112 and electrically couples sensing/working electrode 120 to reference electrode 128. Electrolytic fill solution 132 can be any suitable fluid based on the particular sensing application. Examples of such electrolytic fill solutions include: potassium chloride solution, boric acid buffer, acetic acid buffer, and sodium hydroxide solution Sensing/working electrode 120 and reference electrode 128 are coupled to leads 124, 130, respectively. In accordance with an embodiment of the present invention, counter electrode 140 is employed, but it is physically isolated from electrolytic fill solution 132. In FIG. 2, this physical isolation is illustrated by counter electrode 140 being disposed on an exterior surface of sensor body 112. Counter electrode 140 is coupled to lead 142, such that measurement of current flowing between leads 142 and 124 provides an indication of ion flow, diffusion rate, and ultimately the concentration of the molecules or ions of interest in sample 14.

Operation of sensor 100 is substantially unlike three-electrode amperometric sensors of the prior art. The molecules or ions of interest diffuse across porous membrane 114, and undergo an electrochemical reaction (oxidation/reduction) at working electrode 120 generating a current that flows between working electrode 120 and counter electrode 140. A polarizing voltage is applied to sensor/working electrode 120 to reduce or oxidize the intermediate component, via lead 124. The reaction that occurs at the interface between counter electrode 140 and process sample 14 in response to the current flow generates an undesirable component that could, if it were disposed within sensor 112, contaminate electrolytic fill solution 132. Instead, since counter electrode 140 is separated from electrolytic fill solution 132, this undesirable material simply passes into process sample 14, and does not undesirably affect electrolytic fill solution 132. As a result, electrolytic fill solution 132 will not become contaminated nor degraded by materials generated via current flow into or out of counter electrode 140. It is believed that this will retain the advantages of a three-electrode amperometric sensors while simultaneously significantly increasing the longevity of the electrolytic fill solution.

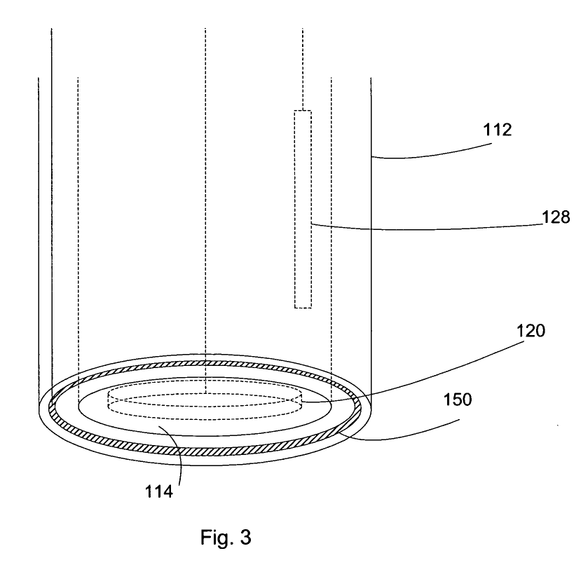

While FIG. 2 illustrates counter electrode 140 being disposed on a side of sensor body 112, in reality, counter electrode 140 can be located in any position that allows it to conduct current between itself and sensing/working electrode 120. For example, FIG. 3 is a diagrammatic view of a three-electrode amperometric sensor having a ring-shaped counter electrode 150 disposed on a surface of distal end 116 proximate membrane 114. In fact, counter electrode 140 need not even be physically coupled to sensor body 112.

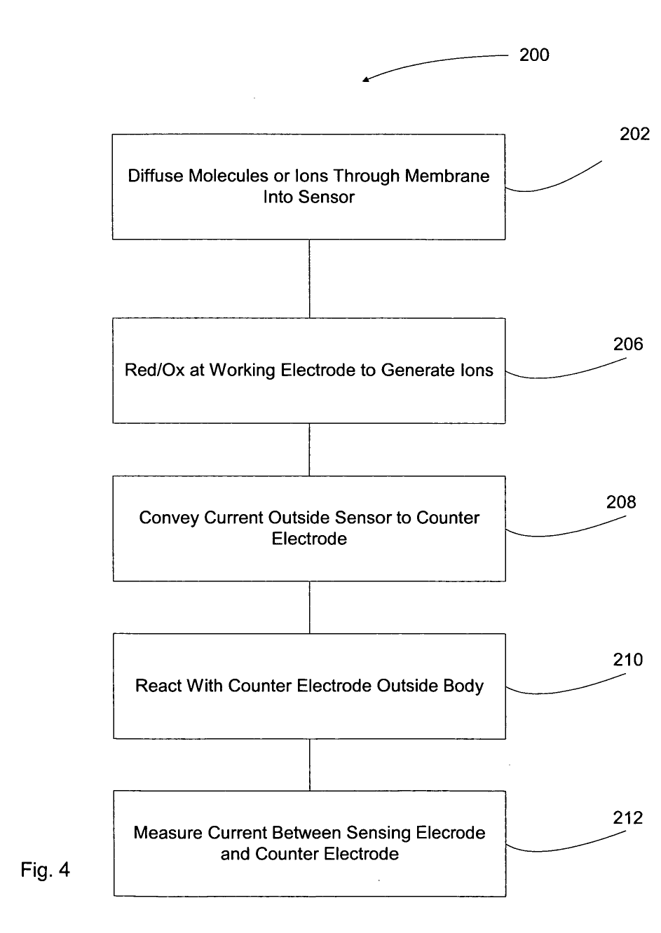

FIG. 4 is a flow diagram of a method of measuring the concentration of molecules or ions of interest in a sample using an amperometric sensor. Method 200 begins at block 202 where the molecules or ions of interest is diffuse through a membrane of the sensor into the interior of the sensor. At block 206, the diffused molecules or ions react with the working electrode via reduction or oxidization, as the case may be, to generate a current that flows between the working electrode and a counter electrode. At block 208, the current is conveyed outside the sensor to a counter electrode. At block 210, the current flow causes an electrochemical reaction at the counter electrode, which reaction occurs away from electrolytic fill solution located inside the sensor. The current is measured at block 212 as an indication of the diffusion rate of the molecules or ions of interest through the membrane and accordingly of the concentration of the molecules or ions of interest in the sample.

Although the present invention has been described with reference to preferred embodiments, workers skilled in the art will recognize that changes may be made in form and detail without departing from the spirit and scope of the invention.

What is claimed is:

1. An amperometric sensor comprising:
a sensor body defining a chamber therein and having a distal end;
a porous membrane disposed proximate the distal end;
a working electrode disposed within the chamber proximate the membrane;
an electrolytic fill solution disposed within the chamber in fluid contact with the working electrode and the membrane; and
a counter electrode isolated from the electrolytic fill solution, wherein current flow between the working electrode and the counter electrode provides an indication of concentration of a molecule or ion of interest.

2. The sensor of claim 1, and further comprising a reference electrode disposed within the chamber to provide an indication of potential of the electrolytic fill solution.

3. The sensor of claim 1, wherein the counter electrode is disposed outside of the sensor body.

4. The sensor of claim 3, wherein the counter electrode is disposed on a side of the sensor body.

5. The sensor of claim 3, wherein the counter electrode is disposed proximate the distal end.

6. The sensor of claim 5, wherein the counter electrode is ring-shaped.

7. The sensor of claim 6, wherein the counter electrode is disposed about the membrane.

8. The sensor of claim 1, wherein the membrane is formed of a material selected from the group consisting of hydrophilic polytetrafluoroethylene, hydrophilic polyvinylidene fluoride, and hydrophilic polyethersulfone

9. A method of sensing a concentration of a molecule or an ion of interest using an amperometric sensor, the method comprising:
diffusing at least some molecules or ions of interest across a porous membrane into the amperometric sensor;
reacting the diffused molecules or ions with the working electrode to generate a current flow;
conveying the current flow to a counter electrode outside the sensor; and
measuring current between the working electrode and the counter electrode.

10. The method of claim 9, wherein the sensor is a three-electrode sensor.

11. The method of claim 9, wherein the current flows to a counter electrode disposed on a side of the sensor.

12. The method of claim 9, wherein the current flows to a counter electrode disposed on a distal end of the sensor.

13. An amperometric sensor comprising:
a sensor body having an interior and a distal end;
a membrane disposed proximate the distal end and adapted to allow diffusion of molecules or ions of interest therethrough;
a working electrode disposed in the interior of the sensor proximate the membrane;
electrolytic fill solution disposed within the sensor; and
counter electrode means for conducting electrical current between the counter electrode means and the working electrode.
